(19) United States
(12) Patent Application Publication
(10) Pub. No.: US 2008/0080198 A1
(43) Pub. Date: Apr. 3, 2008

(54) Motorcycle signal light assembly

(76) Inventor: Orlando Gonzalez, Hialeah, FL (US)

Correspondence Address: MALLOY & MALLOY, P.A.;Historic Coral Way, 2800 S. W. Third Avenue, Miami, FL, 33129, US

(21) Appl. No.: 11/528,834

(22) Filed: Sep. 28, 2006

(51) Int. Cl. B62J 6/00

(52) U.S. Cl. 362/473; 362/474

(57) ABSTRACT

An illumination assembly for a motorcycle structured to be installed primarily, but not exclusively, as an after market product on predetermined portions of a motorcycle and thereby serve as a replacement for the standard lighting of the original manufacturer of the motorcycle. A base of each light structure is dimensioned and configured to be connected to the predetermined portion of the motorcycle, which may comprise an apertured construction and which may be an original, pre-structured part of the motorcycle. Each base includes a casing for the containment of an illumination source on the interior thereof and is dimensioned and configured to protrude outwardly from the exterior surface of the motorcycle to facilitate viewing thereof. The replacement illumination assembly replaces the original signal and/or brake lights of the motorcycle in order to maintain the legal street status thereof, while significantly enhancing the appearance thereof.

### BACKGROUND OF THE INVENTION

1. Field of the Invention

This invention is directed to an illumination assembly for a motorcycle such as, but not limited to, the Suzuki™, Hayabusa™ motorcycle. The illumination assembly includes at least one but more practically two light structures to be installed as an after-market product at or within predetermined portions of the motorcycle. Appropriate, legally required lighting is thereby provided in order to maintain the street legal status of the motorcycle when the original lighting is removed in order to significantly enhance the streamlined appearance of the motorcycle.

2. Description of the Related Art

In accordance with the laws of several states of the United States as well as other countries, a motorcycle intended to be operated on public roadways is required to have appropriate tail lights or brake lights as well as appropriate turn signal lights. As commonly installed and operated, the separate functions of these lights are to serve as running lights, indicate slowing or stopping of the motorcycle and indicate the intended direction of travel of the motorcycle when turning. As such, the requirement to maintain an appropriate lighting system is for the obvious purpose of safety in preventing collisions of motorcycles with the larger, more prevalent automobiles, trucks, or like passenger vehicles.

As commonly designed and installed, the original equipment manufacturer (OEM) includes the turn signal lights being two in number and separated so as to be disposed on opposite sides of the motorcycle. Their activation or operation thereby clearly indicates to surrounding vehicles and/or individuals in which direction the motorcycle is intending to travel. More specifically, a common placement or arrangement of signal lights, and to at least a minimal extent brake lights, is the rear fender of the motorcycle adjacent to, above and on each side of the rear wheel of the motorcycle. Accordingly, today's street legal motorcycles which are available directly from the dealer or manufacturer are equipped with large turn signals that protrude out from the sides of the cycle frame.

The structure, operation and placement of such light assemblies meet required standards in order to maintain the street legal status of the motorcycle. However, many owners or riders have the opinion that the original light assemblies are unsightly because they generally detract from the flush, aerodynamic appearance of modern day cycles. As a result, these OEM light assemblies are frequently removed thereby making the motorcycle illegal in that they do not conform to the signal or running light requirements maintained by most authorities. If not replaced by a more streamlined after market and/or customized light assembly, the altered motorcycle jeopardizes the safety of the rider especially during night time driving conditions. Therefore, it is believed that while most owners or riders of motorcycle are desirous of obtaining a true “streamlined appearance” most responsible individuals are not willing to forego the safety of appropriate lighting. The result and actions of these more responsible individuals are to leave the OEM light assemblies in place or providing a customized replacement therefore.

Accordingly, there is a need in the motorcycle industry for a product, which is preferably, but not necessarily an after market product designed, dimensioned and configured, to greatly facilitate an individual's ability to remove the OEM light assembly and replace it with a more “flushed fitting” light assembly. It is of course noted that among motorcycle enthusiasts, the Suzuki, Hayabusa model is extremely popular due not only to the operative and enhanced performs characteristics of the motorcycle but also the streamlined, aerodynamic appearance thereof.

Therefore a proposed illumination assembly structured to replace OEM motorcycle lighting should compliment the streamlined appearance of the Suzuki, Hayabusa motorcycle, as well as other popular motorcycle models intended to be operated on the roadways. Further, such a proposed and preferred illumination assembly should be structured to facilitate easy, secure and safe attachment such that it is reliably operative to serve as turn signals, running lights, brake lights, etc. once the OEM light assembly has been removed. In addition, a proposed replacement light assembly should be such as to accommodate its operative mounting or connection to predetermined portions of the motorcycle to which it is attached, wherein the predetermined portion of the motorcycle preferably comprises an original, pre-structured part of the cycle. This would eliminate the necessity for further customizing the fenders, fairings, or any other appropriate component of the motorcycle which may accommodate the preferred and proposed replacement illumination assembly.

### SUMMARY OF THE INVENTION

The present invention is directed to an illumination assembly specifically structured to serve as replacement lighting for a motorcycle of the type intended to be operated on the streets or roadways of a given local. Moreover, it is mandated by governing authorities to include appropriate lighting assemblies which serve as running lights, turn signals, brake lights, etc. on motorcycles. While the requirements for an appropriate, legally acceptable illumination assembly for a motorcycle may vary, the minimum typically includes the aforementioned turn signals and/or brake lights. However, many of the motorcycles currently being manufactured and designed include turn signals and/or brake lights which many motorcycle enthusiasts consider as diminishing from the streamlined appearance of many of the modern streamlined motorcycles models. In particular, but not by way of limitation, the Suzuki, Hayabusa model motorcycle is extremely popular with motorcycle enthusiasts. However, it does include certain of the drawbacks or disadvantages of light assembly placement and design, as set forth above.

Accordingly, the illumination assembly of the present invention is primarily structured and designed to serve as an “after market” product which can be easily, quickly and reliably mounted on or installed in one or more “predetermined portions” of the motorcycle in order that the OEM light assembly with which the motorcycle was equipped may be removed. As such, the illumination assembly of the present invention allows for the maintenance of the street legal status of the motorcycle while significantly enhancing the overall appearance by complimenting the streamlined design configuration commonly desired by many motorcycle enthusiasts.

More specifically, the illumination assembly of the present invention comprises at least one light structure, but more commonly, a plurality of at least two light structures. Each of the preferably two light structures are dimensioned and configured to be mounted on cooperatively disposed and at least partially corresponding “predetermined portions” of the motorcycle. As such, the illumination assembly of the present invention may serve as operative turn signal lights and/or brake lights in that each of the preferably two light structures are mounted on opposite sides of the motorcycle adjacent a rear portion thereof. Further, the structural configuration in addition to their operative placement facilitates the individual light structures being disposed in an outwardly protruding orientation thereby facilitating observation of each of the light structures from a variety of different positions which may be assumed by individuals and/or other motor vehicles in the vicinity of the modified motorcycle.

Each of the one or more light structures includes a base structured to be connected to the predetermined portion of the motorcycle in the aforementioned exteriorly observable position. In at least one preferred embodiment of the illumination assembly of the present invention, each light structure is removably connected to the motorcycle in the aforementioned predetermined portion, thereby further facilitating the installation and removal of the one or more light structures, as desired. Moreover, each of the light structures includes a casing connected to the base and dimensioned and configured to protrude outwardly from the exterior surface of the motorcycle as the base is securely and operatively connected to the aforementioned predetermined portion. An illumination source comprising any of a variety of one or more illumination elements such as, but not limited to, incandescent lamps, light emitting diodes (LED), etc. are mounted on the interior of the casing. As such each illumination source is cooperatively disposed and structured relative to the casing to generate illumination through the casing which is formed of a transparent, translucent or otherwise light transmitting material.

As explained in greater detail hereinafter, the aforementioned “predetermined portions” of the motorcycle to which each of the preferably two light structures are mounted or connected preferably comprise an apertured construction. In the aforementioned very popular Suzuki, Hayabusa model motorcycle, such an apertured construction exists on the cycle as an original, pre-structured part thereof. Accordingly, each aperture or apertured construction is located on opposite sides of a fender or other component generally adjacent to but rearward of the seat portion of the motorcycle. The two apertured constructions of the aforementioned type of motorcycle have distinct configurations, which may be originally intended for use or cooperation with components other than light structures. However, these original apertured constructions are clearly appropriate for placement and mounting of the individual light structures of one or more embodiments of the illumination assembly of the present invention.

Therefore, the base of each of the light structures preferably includes a peripheral structure or construction which corresponds in dimension and configuration to the peripheral configuration of a corresponding one of the apertured constructions. Also the base is otherwise structured to greatly facilitate a “plug in” type of installation. As such, the base of the casing, along with its peripheral construction, may include a recess or elongated peripheral groove formed therein. Again, the peripheral groove of the base is such as to receive or at least partially enclose the peripheral edge or appropriate peripheral portion of the apertured construction of the motorcycle. In addition, the peripheral construction of the base may include an at least minimally flexible material so as to engage contiguous portions of the periphery of the apertured construction in a manner which accomplishes a sealing engagement. This sealing engagement is sufficient to restrict the unwanted entry of water into the interior of the motorcycle, through junction of each light structure and a corresponding one of the apertured constructions.

In addition to the above, an appropriate connection assembly may be provided to establish an operative, electrical interconnection between the illumination source mounted on the interior of the casing and the power supply of the motorcycle as well as any operative or control components associated therewith. In the latter category appropriate control components of the motorcycle will be such as to cause an activation of an appropriate one of the light structures when the turn signal controls are operated and/or when the brake of the motorcycle is applied.

It is emphasized that at least one preferred embodiment of the illumination assembly of the present invention comprises one more light structures being specifically dimensioned, configured and otherwise adapted to be mounted on a Suzuki, Hayabusa motorcycle. However, it is also within the intended spirit and scope of the present invention to facilitate the mounting of the illumination assembly of the present invention on other motorcycles with minimum or no structural modifications.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a side, perspective view in partial cutaway of the one light structure comprising a preferred embodiment of the illumination assembly of the present invention mounted in a predetermined position on a motorcycle.

FIG. 2 is a front end view in partial cutaway representing both interior and exterior portions of one light structure of the preferred embodiment of FIG. 1, while not being mounted on or connected to the motorcycle.

FIG. 3 is a rear view of the embodiment of FIG. 2.

FIG. 4 is a rear end view of the embodiment of FIG. 1 wherein two light structures are operatively mounted on corresponding, predetermined portions of the motorcycle and further wherein the light assembly of the original equipment manufacturer are represented in phantom lines as being removed from the motorcycle.

FIG. 5 is yet another embodiment varying in dimension and/or configuration from the preferred embodiment of FIG. 4.

FIG. 6 is yet another preferred embodiment varying in dimension and/or configuration from the preferred embodiments of FIGS. 4 and 5.

FIG. 7 is yet another preferred embodiment varying in dimension and/or configuration from the preferred embodiments of FIGS. 4-6.

FIG. 8 is yet another preferred embodiment varying in dimension and/or configuration from the preferred embodiments of FIGS. 4-7.

Like reference numerals refer to like parts throughout the several views of the drawings.

### DETAILED DESCRIPTION OF THE PREFERRED EMBODIMENT

As shown in the accompanying drawings, the present invention is directed to a light assembly generally indicated as 10 structured to be mounted on or connected to a motorcycle generally indicated as 12. In addition, one or more of the preferred embodiments of the illumination assembly 10 is structured to be mounted on the motor cycle 12 as an “after-market product and as a replacement for the original lighting with which the cycle 12 was manufactured.

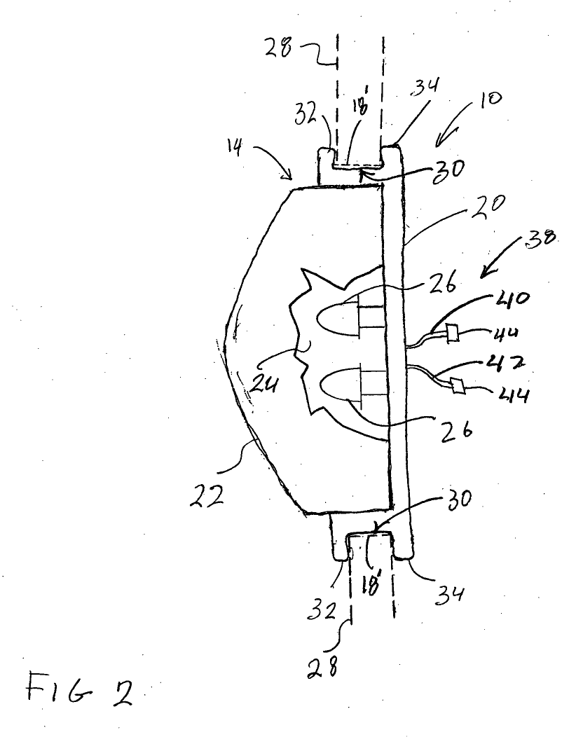

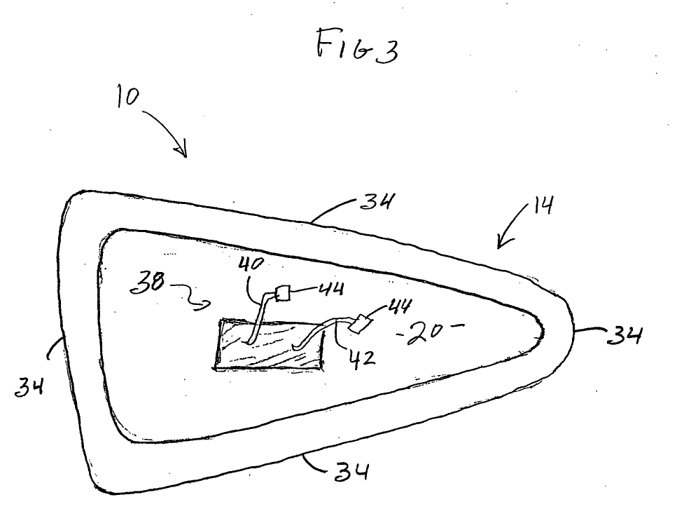

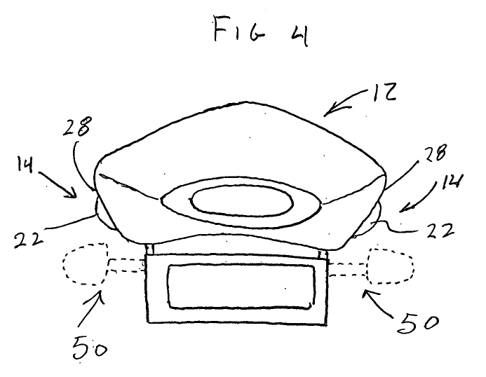

In a most preferred embodiment, the light assembly 10 includes at least one but more practically at least a plurality of two light structures 14. Each of the preferably two light structures 14 have corresponding or substantially equivalent structural features but may differ in an overall configuration based on the two light structures 14 being mounted on or connected to predetermined portions 16 on opposite sides of the motorcycle 12 as schematically represented in FIGS. 4-8. Accordingly, the various structural and operative features of each of the light structures 14 will be described in detail, especially with reference to FIGS. 2 and 3, by referring to a single one of the preferably two light structures 14. Accordingly, other than a possible “reversed” configuring of the light structures 14, due to the mounting or positioning thereof on opposite sides of the cycle 12, a description of one of the light structures 14 is intended to be representative of a detailed description of each of the light structures 14.

As set forth above, a most preferred embodiment of the light assembly 10 comprises each of the one or more light structures 14 comprising an “after market” product which are not a part of the original equipment manufactured or assembled with the motorcycle 12. In addition, each of the light structures 14 are intended to be mounted or connected to a “predetermined portion” of the motorcycle 12. Moreover, the predetermined portion preferably comprises an apertured construction generally indicated as 18. As such, the apertured construction 18 includes a surrounding peripheral edge or portion 18′. To facilitate mounting thereof, each of the light structures 14 are configured, dimensioned and structured to establish a confronting, at least partially sealing engagement with the periphery 18′ or portions of the cycle 12 contiguous thereto.

Further by way of example, a popular motorcycle currently commercially available is the Suzuki, Hayabusa motorcycle. This model includes an “apertured construction” on each side of the cycle 12 which define respective predetermined portions 16 to which the different light structures 14 are connected. Each apertured construction 18 has a somewhat elongated streamlined appearance and is originally intended to serve as a mounting or connection for a decorative and/or functional insert on each side of the motorcycle 12. As such, each of the light structures 14 are specifically dimensioned, and configured to be connected to or inserted in a different one of the apertured constructions 18 of the predetermined portions 16.

More specifically, and with primary reference to FIGS. 2 and 3, each of the preferably two light structures 14 includes a base 20 and a casing 22 connected to the base 20. The casing 22 is formed by transparent, translucent or other material through which light may pass. Each casing further includes an at least partially hollow interior 24 of sufficient dimension to contain at least one or a plurality of light generating elements 26. The light generating elements are schematically represented and as such may take the form of one or more incandescent lamps, a plurality of light emitting diodes (LED) or any other appropriate light generating element capable of generating enough light to facilitate use of each of the light structures 14 as running lights, turn signal lights, brake lights, etc.

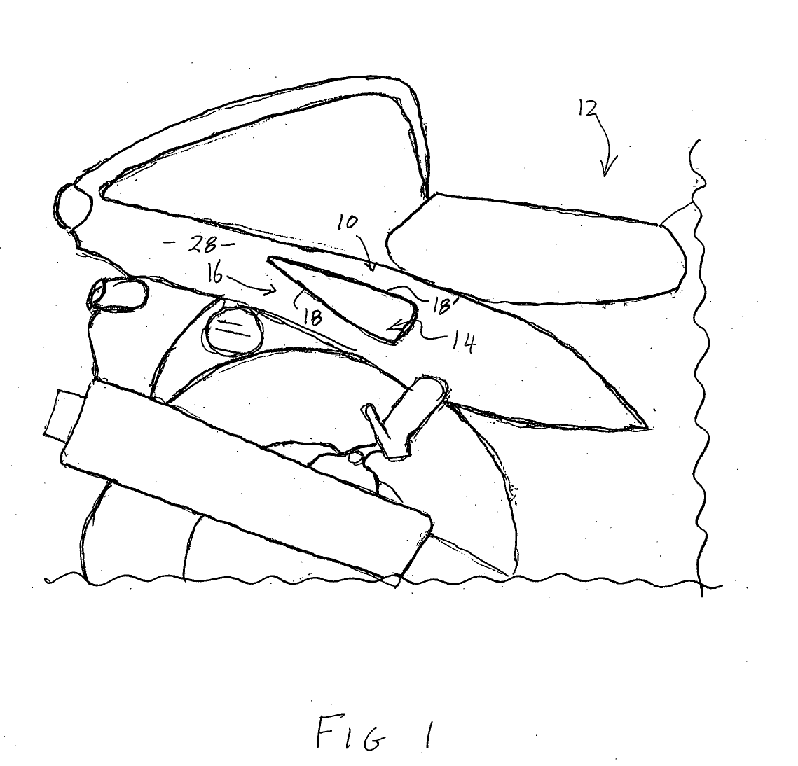

Further, the casing 22 is cooperatively dimensioned and configured with the base 20 and both are cooperatively dimensioned and configured to correspond to the dimension and configuration of the apertured construction 18 and more specifically the periphery 18′ thereof. Also, the casing is further configured so as to protrude outwardly from the predetermined portion 16 and an adjacent, corresponding exterior surface 28 of the motorcycle 12. The outward extension of the casings 22 should be sufficient to allow the light structures 14 to be clearly observable from an area adjacent, rearward or surrounding the motorcycle 12. Therefore, in the embodiment of FIGS. 1 and 4-8 the casing 22 extends outwardly from the predetermined portion 16 and also from the exterior surface 28 of a fender or other body part on which the light structures are mounted.

In order to facilitate a stable, secure, possibly removable and quick and easy connection of each of the light structures 14 to corresponding ones of the predetermined portions 16, the base 20 comprises an elongated peripheral recess or groove generally indicated as 30. The recess or groove 30 extends along at least a portion and preferably along a majority of the outer periphery of the base 20 as represented in FIG. 2. Further, the depth and width of the recess of groove 30 is such as to receive and retain the corresponding periphery 18′ of the apertured construction 18 of the predetermined portions 16 therein.

Further, the groove is bordered by at least one outwardly extending lateral flange 32. However, a most preferred embodiment of the light structure 14 includes spaced apart, substantially oppositely disposed flanges 32 and 34 disposed laterally on opposite sides of the groove 30 and cooperatively defining the boundaries thereof. Each of the flanges 32 and 34 extend along at least a portion of the length of the recess or groove 30 and are cooperatively dimensioned to facilitate retention of the periphery 18′ of the apertured construction 18 therein such that the flanges 32 and 34 engage surfaces contiguous to the periphery 181. By virtue of this construction and further due to the fact that the flanges 32 and 34 and/or additional adjacent or corresponding portions of the groove or recess 30 are formed from a flexible material, a water restrictive seal is formed between the base 20 and the periphery 18′ and/or contiguous portions of the apertured construction 18. Such a sealing engagement is sufficient to restrict the entry of water or the like, such as when the motorcycle 12 is exposed to harsh weather conditions. For purposes of clarity, the periphery 18′ of the apertured construction 18 defining the respective predetermined portions 16 is represented in phantom lines in FIG. 3. Also schematically represented is the water restrictive seal formed by the flanges 32 and 34 engaging opposite surfaces of the fender or other body component 28 in which the apertured construction 18 of the respective predetermined portions 16 are formed.

With primary reference to FIG. 3, the illumination assembly of the present invention also comprises a connecting assembly generally indicated as 38 passing from the interior 24 of the casing 22. The connecting assembly 38 more specifically defines at least one but more practically a plurality of conductors 40 and 42 which include an appropriate connector or terminal 44. As such, the connecting assembly 38 and more specifically the one or more conductors 40 and 42 serve to operatively and electrically interconnect the one or more illumination sources 26 to the power supply of the motorcycle 12 (not shown for purposes of clarity) and/or to control components associated with the operation and/or activation of the illuminating elements 26. Therefore, the connecting assembly 38 not only provides electrical power for the operation of the one or more illumination elements 26 but also serves to regulate the activation thereof such as causing the illumination thereof when the turn signal control, brake, etc. is operated by a rider of the motorcycle 12.

With primary reference to FIGS. 4-8, the illumination assembly 10 of the present invention in a most preferred embodiment is intended for use as an after market product which provides proper lighting for the motorcycle 12 while significantly increasing the overall aesthetic appearance and maintaining the streamlined look of the Suzuki, Hayabusa motorcycle, as well as a variety of other motorcycle models. The desirability of the illumination assembly 10 occurs by the preference of motorcycle enthusiasts to maintain his or her motorcycle “street legal” by having the appropriate brake lights, running lights, turn signal lights, etc. mounted thereon. Accordingly, in order to enhance the overall aesthetic appearance of the motorcycle 12 the conventional turn signal lights and/or other brake/running lights, generally indicated in phantom lines as 50, are removed. As set forth in detail above, removal of the OEM lights 50 without adding an additional illumination assembly, such as defined by the present invention, would render the motorcycle 12 illegal in terms of its ability to be driven on the roadways of most jurisdictions.

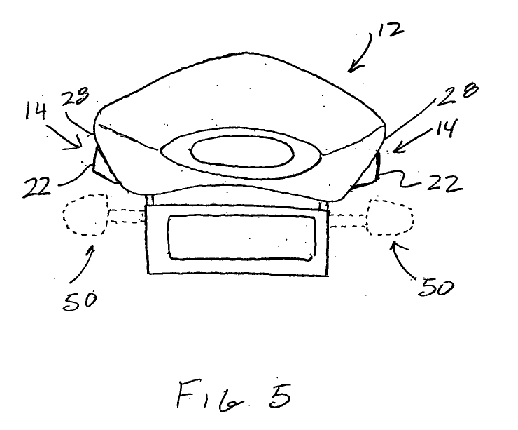

As shown in FIG. 4, the casings 22 are disposed in an outwardly protruding orientation and their substantially rounded or curved transverse configuration allows them to be viewed from the rear of the motorcycle during travel. Somewhat similarly, the additional preferred embodiment of FIG. 5 has the transverse dimension and/or configuration of each casing 22 having a more angled shape than that represented in FIG. 4.

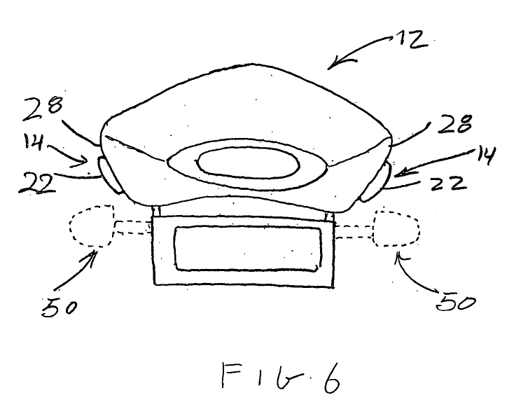

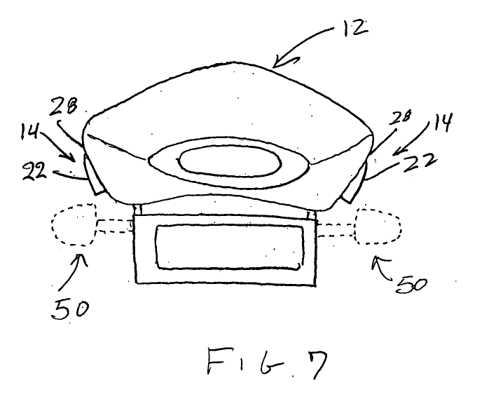

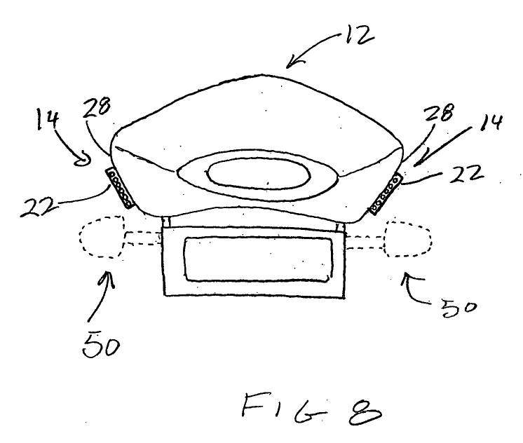

Additional embodiments of the light structures 14 are represented in FIGS. 6-8 wherein the transverse configuration of the casing 22 provides differently configured outwardly protruding shapes especially, but not exclusively, when viewed from the rear of the motorcycle 12. More specifically, FIG. 6 provides a curved but more elongated transverse configuration of the casing 22. FIG. 7 provides a combined elongated curved transverse configuration and a linear segment extending along a bottom portion of the casing 22. In addition, another preferred embodiment is represented in FIG. 8, wherein the casing 22 may include a plurality of illuminated segments each being schematically representative of one of a plurality of LED's mounted on the interior 24 of the respective casings 22.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. An illumination assembly for a motorcycle comprising:
at least one light structure,
said light structure comprising a base structured to be connected to a predetermined portion of the motorcycle in an exteriorly observable position,
a casing connected to said base and dimensioned and configured to assume an outwardly protruding orientation relative to said predetermined portion,
an illumination source mounted within said casing and cooperatively disposed and structured with said casing to direct generated illumination there through, and
said base being at least partially configured to correspond to a configuration of said predetermined portion of the motorcycle.

2. An illumination assembly as recited in claim 1 wherein said predetermined portion comprises an original, pre-structured part of the motorcycle.

3. An illumination assembly as recited in claim 1 wherein said base is structured to be connected to an apertured construction of the motorcycle.

4. An illumination assembly as recited in claim 3 wherein said apertured construction at least partially defines said the predetermined portion of the motorcycle.

5. An illumination assembly as recited in claim 4 wherein said base is cooperatively structured with the predetermined portion to define an attachment with a periphery of the apertured construction.

6. An illumination assembly as recited in claim 5 wherein said base comprises a periphery at least partially formed of a flexible material.

7. An illumination assembly as recited in claim 4 wherein said base comprises a recess formed at least partially about a periphery thereof; said recess cooperatively configured and dimensioned to engage a periphery of the apertured construction of the motorcycle.

8. An illumination assembly as recited in claim 7 wherein said periphery of said base contiguous to said recess is formed of an at least partially flexible material.

9. An illumination assembly as recited in claim 7 wherein said recess comprises an elongated groove formed in and extending along at least a portion of said periphery of said base; at least one flange extending along a length of said groove and defining a boundary thereof.

10. An illumination assembly as recited in claim 9 further comprising two flanges each extending along the length of said groove on opposite sides thereof and collectively defining lateral boundaries of said groove.

11. An illumination assembly as recited in claim 10 wherein said two flanges are disposed in substantially sealingly engagement with peripheral portions of the apertured construction.

12. An illumination assembly as recited in claim 1 wherein the predetermined portion comprises an original, pre-structured part of a Suzuki, Hayabusa motorcycle.

13. An illumination assembly as recited in claim 1 wherein said base is removably connected to said predetermined portion.

14. An illumination assembly as recited in claim 1 wherein said illumination source comprises a plurality of light emitting diodes.

15. An illumination assembly for a motorcycle comprising:
at least two light structures mounted on the motorcycle in generally opposing and cooperative relation to one another,
each light structure including a base structured to be installed on a different, corresponding predetermined portion of the motorcycle,
each base including a casing connected thereto, each casing dimensioned and configured to assume an outwardly protruding orientation relative to corresponding ones of said predetermined portions,
an illumination source mounted within each of said casings and cooperatively disposed and structured with said casing to direct generated illumination through said casing, and
each base being dimensioned and configured to correspond to respective ones of said predetermined portions.

16. An illumination assembly as recited in claim 15 wherein each predetermined portion comprises an original, pre-structured part of a Suzuki, Hayabusa.

17. An illumination assembly as recited in claim 15 wherein each of the predetermined portions comprise an original, pre-structured part of the motorcycle.

18. An illumination assembly as recited in claim 17 wherein each of the predetermined portions comprises an apertured construction.

19. An illumination assembly as recited in claim 18 wherein said base is cooperatively structured with the predetermined portion to define a removable attachment with a periphery of the apertured construction.

20. An illumination assembly as recited in claim 19 wherein each of said bases comprises a recess formed at least partially about a periphery thereof, each of said recess cooperatively configured and dimensioned to engage a periphery of the apertured construction of the motorcycle.

21. An illumination assembly as recited in claim 20 wherein said periphery of each of said bases contiguous to said recess is formed of an at least partially flexible material.

22. An illumination assembly as recited in claim 20 wherein each of said recesses comprises an elongated groove formed in and extending along at least a portion of said periphery of said base; at least one flange extending along a length of said groove and defining a boundary of said groove.

23. An illumination assembly as recited in claim 22 further comprising two flanges each extending along the length of a corresponding one of said grooves on opposite sides thereof, said flanges collectively defining lateral boundaries of said groove.

24. An illumination assembly as recited in claim 23 wherein said two flanges are disposed in substantially sealingly engagement with peripheral portions of the apertured construction.

25. An illumination assembly as recited in claim 15 further comprising a connection assembly disposed and structured to electrically connect said illumination source to a power supply of the motorcycle.

26. An illumination assembly as recited in claim 15 wherein each of said bases is structured to be removably connected to a corresponding ones of the predetermined portions of the motorcycle.

27. An illumination assembly as recited in claim 26 wherein each of said bases is structured to be removably connected to a corresponding one of the predetermined portions of a Suzuki, Hayabusa.
